(19) United States
(12) Patent Application Publication
(10) Pub. No.: US 2005/0072730 A1
(43) Pub. Date: Apr. 7, 2005

(54) Papermaking strainer

(75) Inventor: Yoshihiko Aikawa, Shizuoka-shi (JP)

Correspondence Address: HAUPTMAN KANESAKA BERNER Patent Agents, LLP, Suite 310, 1700 Diagonal Road, Alexandria, VA, 22314, US

(73) Assignee: AIKAWA IRON WORKS CO., LTD.

(21) Appl. No.: 10/943,969

(22) Filed: Sep. 20, 2004

(30) Foreign Application Priority Data
Oct. 7, 2003 (JP) 2003-347875

(51) Int. Cl. B01D 29/07

(52) U.S. Cl. 210/483; 210/484; 210/499

(57) ABSTRACT

A papermaking strainer removes a foreign material from papermaking raw materials. The papermaking strainer includes a strainer member having a plurality of first openings; a strainer supporting member having a plurality of second openings; and a fastener device for fixing the strainer members to the strainer supporting member. The strainer supporting member contacts and supports the strainer member. The first openings are communicated with the second openings, and the strainer member is arranged at an inflow side of the papermaking raw materials. When the papermaking strainer is damaged or worn down in use, it is possible to easily replace the strainer member for repair.

### BACKGROUND OF THE INVENTION AND RELATED ART STATEMENT

The present invention relates to a papermaking strainer. More specially, the present invention relates to a papermaking strainer, wherein a part thereof can be replaced easily for repair when the papermaking strainer is damaged or worn down in use.

A papermaking strainer is provided for removing a foreign material from papermaking raw materials dissociated by a rotational impeller (for example, refer to Japanese Patent Publication (Kokai) No. 06-57666). Such a papermaking strainer may be damaged or worn down due to a foreign material contained in the papermaking raw materials. In such a case, it is necessary to replace an entire portion of the papermaking strainer even though only a part thereof facing an inflow side of the papermaking raw materials is damaged or worn down. Accordingly, it is difficult to use the papermaking strainer efficiently in terms of effective use of members.

In view of the problem, the present invention has been made, and an object of the invention is to provide a papermaking strainer wherein a part thereof can be replaced easily for repair.

Further objects and advantages of the invention will be apparent from the following description of the invention.

### SUMMARY OF THE INVENTION

In order to achieve the object described above, according to a first aspect of the present invention, a papermaking strainer removes a foreign material from papermaking raw materials. The papermaking strainer includes a strainer member having a plurality of first openings; a strainer supporting member having a plurality of second openings and contacting the strainer member for supporting the same; and fastener means for fixing the strainer member to the strainer supporting member. The first openings are communicated with the second openings, and the strainer member is located on an inflow side of the papermaking raw materials.

According to a second aspect of the papermaking strainer, in the papermaking strainer in the first aspect, the strainer member is divided and faces the inflow side of the papermaking raw materials.

According to a third aspect of the present invention, in the papermaking strainer in the first aspect, each of the first openings has a size same as that of each of the second openings, and each of the first openings and each of second openings are coincided and communicated with each other. The strainer supporting member contacts a portion of the strainer member opposite to the surface thereof facing the inflow side of the papermaking raw materials other than the first openings for supporting the strainer member.

According to a fourth aspect of the present invention, in the papermaking strainer in the first aspect, each of the second openings has a size larger than that of each of the first openings, so that the second openings are enlarged as an exit of the papermaking raw materials flowing in the second openings through the first openings.

Conventionally, when a papermaking strainer is damaged or worn down in use, it is necessary to replace an entire portion of the papermaking strainer. In the first aspect of the present invention, the papermaking strainer includes the strainer member and the strainer supporting member separated from the strainer member for supporting the strainer member. Accordingly, when the papermaking strainer is damaged or worn down in use, it is possible to replace the strainer member that is relatively easy to be damaged or worn down. That is, when the papermaking strainer needs to be replaced, only a partial member thereof can be replaced for repair.

In the second aspect of the present invention, the strainer member is divided in several members and the divided members include a part facing the inflow side of the papermaking raw materials dissociated by a pulper. Accordingly, in addition to the advantage of the first aspect, it is possible to easily replace only a part damaged or worn down for repair.

In the third aspect of the present invention, each of the first openings has a size same as that of each of the second openings, and the first openings and the second openings are coincided and communicated with each other. Accordingly, in addition to the advantage of the first aspect, the papermaking raw materials flow into the first openings and flow out the second openings without significant resistance through a passage between the first openings and the second openings. The strainer supporting member contacts a portion of the strainer member opposite to the surface thereof facing the inflow side of the papermaking raw materials other than the first openings for supporting the strainer member, thereby reinforcing the strainer member.

In the fourth aspect of the present invention, each of the second openings has a size larger than that of each of the first openings, so that the second openings are enlarged as an exit of the papermaking raw materials flowing in the second openings through the first openings. Accordingly, in addition to the advantage of the first aspect, the papermaking raw materials easily flow in the first openings and flow out the second openings.

### BRIEF DESCRIPTION OF THE DRAWINGS

FIG. 1 is a cross sectional view of a pulper provided with a papermaking strainer according to an embodiment of the present invention;

FIG. 2 is an enlarged sectional view of the papermaking strainer shown in FIG. 1;

FIG. 3 is an exploded sectional view of the papermaking strainer shown in FIG. 2;

FIG. 4 is a plan view of a strainer supporting member shown in FIG. 2;

FIG. 5 is a cross sectional view of the strainer supporting member taken along line 5-5 in FIG. 4;

FIG. 6 is a plan view of a strainer member shown in FIG. 2;

FIG. 7 is a cross sectional view of the strainer member taken along line 7-7 in FIG. 6;

FIG. 8 is a plan view of a ring-shaped member shown in FIG. 2;

FIG. 9 is a cross sectional view of the ring-shaped member taken along line 9-9 in FIG. 8;

FIG. 10 is a cross sectional view of first openings and second openings;

FIG. 11 is a cross sectional view of first openings and second openings different from those shown in FIG. 9; and

FIG. 12 is a cross sectional view of a papermaking strainer different from that shown in FIG. 2.

### DETAILED DESCRIPTION OF PREFERRED EMBODIMENTS

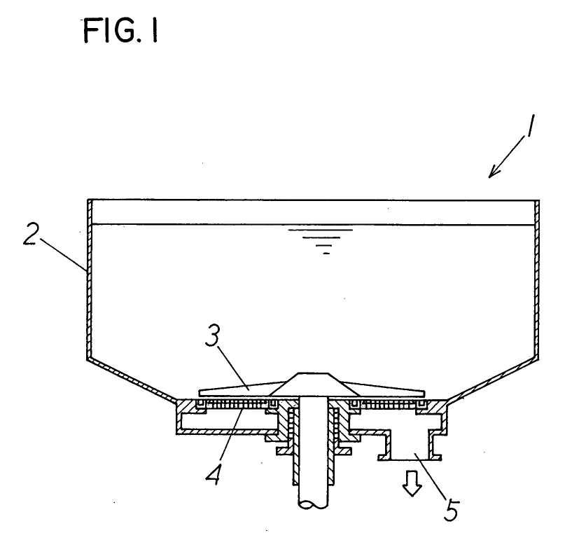

Hereunder, embodiments of the present invention will be explained with reference to the accompanying drawings. In FIG. 1, reference numeral 1 represents a pulper for dissociating papermaking raw materials such as used paper and so on. In the pulper 1, a rotor 3 rotates in a tank 2 to produce a vortex flow in water to dissociate the papermaking raw materials. Dissociated useful fibers in the papermaking raw materials pass through a papermaking strainer 4 provided adjacent to the rotor 3, and are guided to the outside of the tank 2 through an outlet 5. The papermaking strainer 4 is provided for removing a foreign material from the papermaking raw materials. The foreign material in the papermaking raw materials does not pass through the papermaking strainer 4, and remains inside the tank 2. Then, the foreign material is guided to the outside of the tank 2 through an outlet (not shown) communicating with the inside of the tank 2.

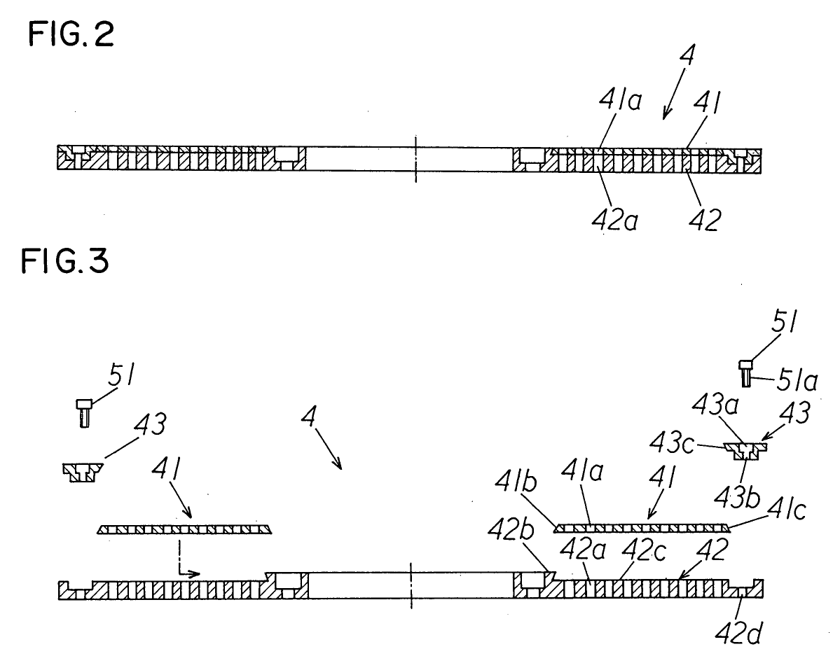

As shown in FIGS. 2 and 3, the papermaking strainer 4 includes strainer members 41 having a plurality of first openings 41a and a strainer supporting member 42 having a plurality of second openings 42a. The strainer supporting member 42 contacts and supports the strainer members 41. The strainer members 41 are fixed to the strainer supporting member 42 by fastener means. The first openings 41a communicate with the second openings 42a, and the strainer members 41 are located at an inflow side of the papermaking raw materials.

Conventionally, when a papermaking strainer is damaged or worn down in use, it is necessary to replace an entire portion of the papermaking strainer. In the embodiment of the present invention, the papermaking strainer 4 includes the strainer members 41 and the strainer supporting member 42 supporting the strainer members 41. When the papermaking strainer 4 is damaged or worn down, it is possible to replace only the strainer members 41 that are easy to be damaged or worn down. Accordingly, the papermaking strainer 4 is replaced merely by replacing a partial member thereof.

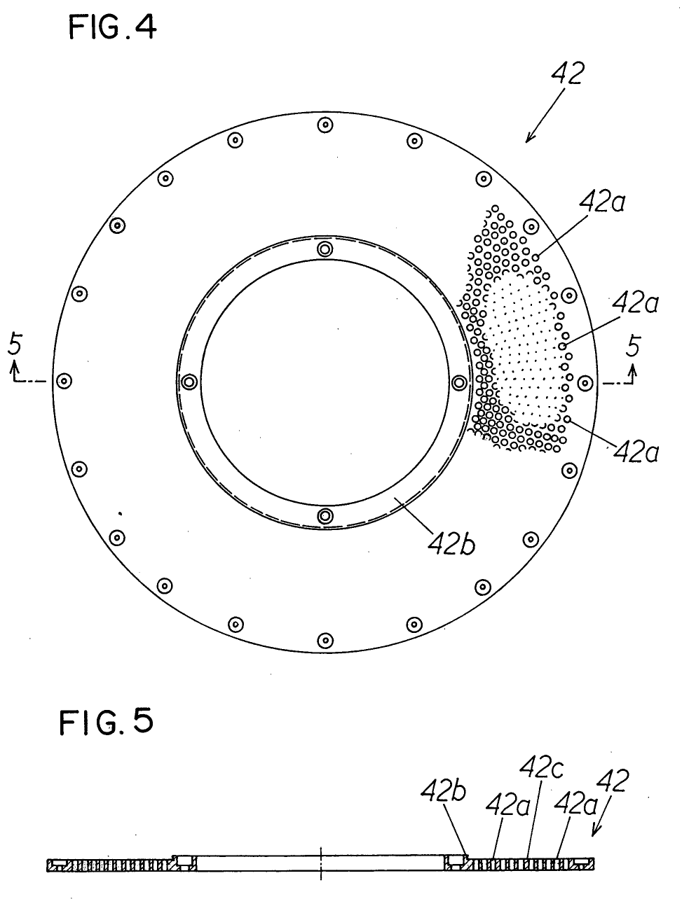

The strainer supporting member 42 has a roughly doughnut-shape (see FIGS. 4 and 5). A protrusion 42b having a column shape elevated from a surrounding is provided at a central part of the strainer supporting member 42. A housing portion 42c extends toward an outer circumference of the strainer supporting member 42 from a lower position of the protrusion 42b for housing the strainer members 41. Female screws 42d are provided at positions near an outer circumference of the strainer supporting member 42. A side surface of the protrusion 42b has a tapered shape expanding outwardly. The second openings 42a are provided in the housing portion 42c and have a circular cross section in a lateral direction.

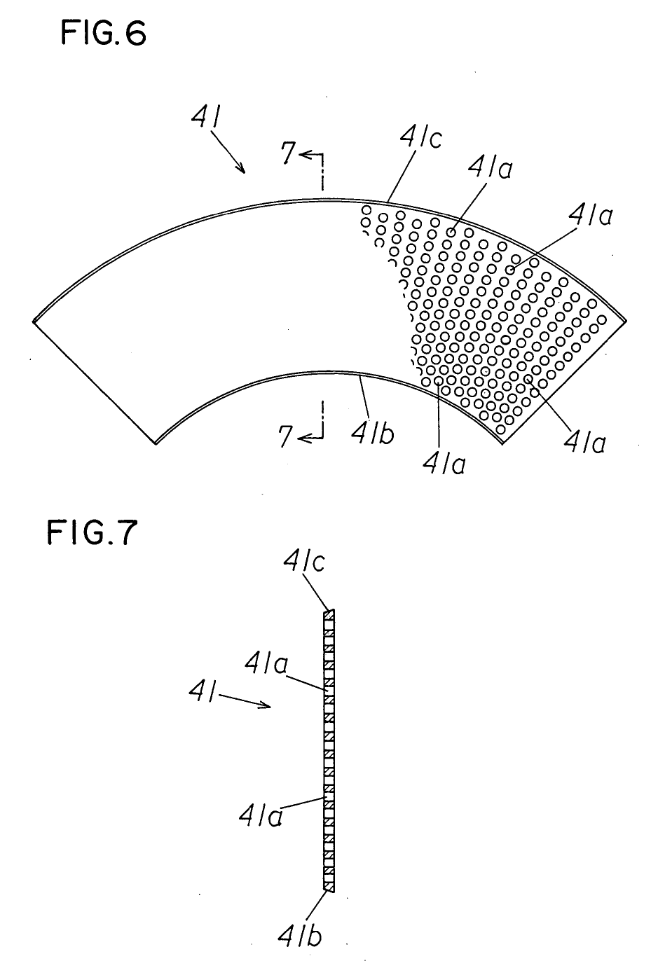

As shown in FIGS. 6 and 7, the strainer members 41 have a doughnut-shape when the strainer members 41 are housed in the strainer supporting member 42. In the embodiment, the strainer members 41 are divided members (for example, four members), and the strainer members include portions facing an inflow side of the dissociated papermaking raw materials. In other words, the strainer members 41 are divided and have the portions facing the inflow side of the dissociated papermaking raw materials. The first openings 41a of the strainer members 41 have a circular opening, and may have an appropriate shape such as a triangle, quadrangle, polygon, and so on.

A tip portion 41b of the strainer member 41 (tip portion 41b located at an inner circumference of the strainer member 41) contacts the side surface of the protrusion 42b, and has a reverse tapered shape corresponding to the tapered shape of the side surface of the protrusion 42b. The tip portion 41b at the inner circumference of the strainer member 41 and a tip portion 41c at an outer circumference of the strainer member 41 are inclined such that a distance therebetween decreases toward the inflow side of the papermaking raw materials from an opposite side. The strainer members 41 may be integrated into a single member with a doughnut-shape. In the case that the strainer members 41 are the divided members, it is easy to replace a partial member thereof for repair when the strainer member 41 is damaged or worn down.

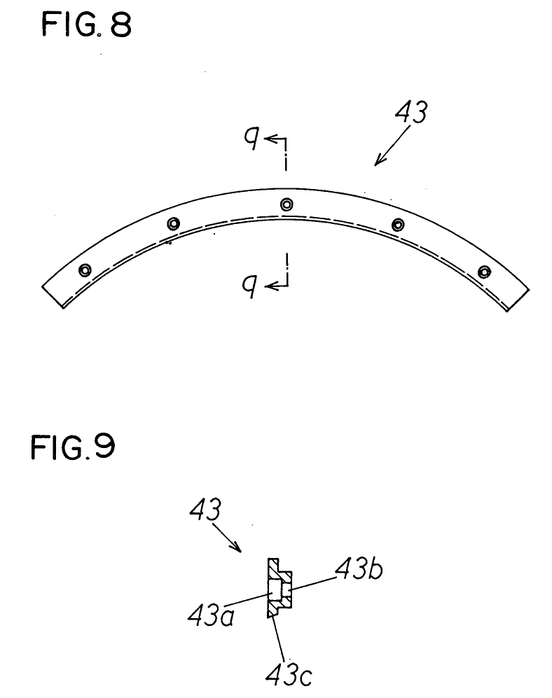

Reference numeral 43 represents ring-shaped members. The ring-shaped members 43 have a ring shape when the strainer member 41 is fixed to the strainer supporting member 42 through the ring-shaped members 43 and fastener means (described later). In the embodiment, the ring shaped members 43 are divided pieces (for example, four pieces). Each of the ring shaped members 43 includes a recess 43a for housing a head of a bolt 51, and a bore 43b for inserting the bolt 51. A portion 43c of the ring-shaped member 43 contacts the tip portion 41c of the strainer member 41, and is formed in a reversed slope corresponding to the tip portion 41c (see FIGS. 8 and 9).

The fastener means fixes the strainer members 41 to the strainer supporting member 42, and may include welding for firmly fixing the strainer members 41 to the strainer supporting member 42. In the embodiment, the strainer members 41 are attached to the strainer supporting member 42 with the bolts 51 so that the strainer members 41 are detachable. When the strainer members 41 are attached to the strainer supporting member 42, the slope of the tip portion 41b of each of the strainer members 41 is aligned to the slope of the side surface of the strainer supporting member 42, and the portion 43c of each of the ring-shaped members 43 is aligned to the tip portion 41c of each of the strainer members 41. Then, a male screw 51a of the bolt 51 is screwed in the female screw 42d provided in the strainer supporting member 42 through the bore 43b provided in the ring-shaped member 43.

The first openings 41a communicate with the second openings 42a. As shown in FIG. 10, the first openings 41a may have a size (circular cross section) same as that (circular cross section) of the second openings 42a, and the first openings 41a are coincided and communicate with the second openings 42a. With this structure, there is no resistance in passages between the first openings 41a and the second openings 42a. Accordingly, the papermaking raw materials flow into the first openings 41a and flow out the second openings 42a without resistance. The strainer supporting member 42 contacts a portion of the strainer members 41 opposite to the inflow side of the papermaking raw materials other than the first openings 41a, thereby stably supporting and reinforcing the strainer member 41.

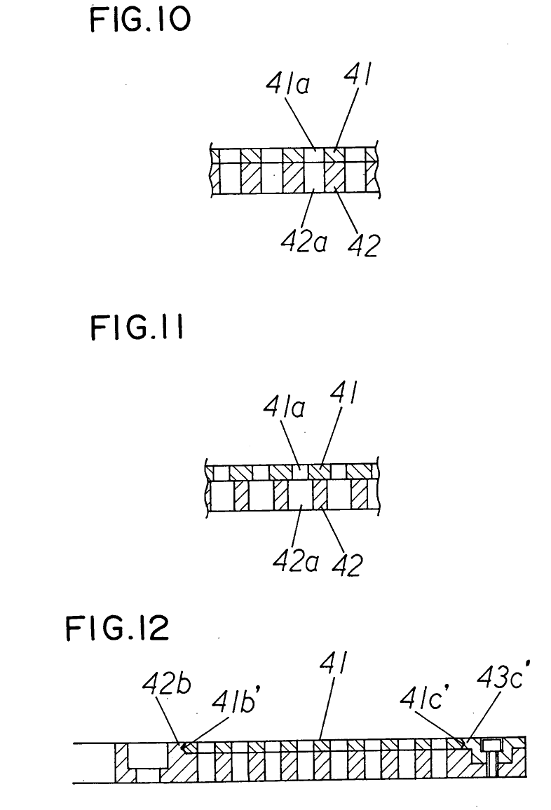

As shown in FIG. 11, the second openings 42a may have a size (circular cross section) larger than that (circular cross section) of the first openings 41a, so that the second openings 42a have a larger opening as an exit of the papermaking raw materials flowing through the first openings 41a. With this structure, the papermaking raw materials easily flow in the first openings 41a and flow out the second openings 42a, thereby increasing a treatment capacity.

As shown in FIG. 12, the tip portion 41b′ at the inner circumference and the tip portion 41c′ at the outer circumference of each of the strainer members 41 may be formed in a convex shape or a mountain shape. Corresponding to the tip portions 41b′ and 41c′, the side surface of the protrusion 41b and the portion 43c of each of the ring-shaped members 43 are formed in a concave shape or a valley-shape. Accordingly, when the strainer member 41 is damaged or worn down in use, it is possible to turn over the strainer member 41 and install upside down. Alternatively, the tip portion 41b′ may be formed in a concave shape and the side surface of the protrusion 42b may be formed in a convex shape. Further, the tip portion 41b′ and the side surface of the protrusion 42b may be formed in an even and smooth surface, and the strainer member 41 is fixed to the strainer supporting member 42 with welding.

In the embodiments, the papermaking strainer 4 is applied to the pulper 1. According to the present invention, the papermaking strainer 4 is also applicable to other dissociating machines.

The disclosure of Japanese Patent Application No. 2003-347875 filed on Oct. 7, 2003 is incorporated in the application.

While the invention has been explained with reference to the specific embodiments of the invention, the explanation is illustrative and the invention is limited only by the appended claims.

1. A papermaking strainer for removing a foreign material from a papermaking raw material, comprising:
a strainer member disposed at an inflow side of the papermaking raw material and having a plurality of first openings,
a strainer supporting member abutting against the strainer member for supporting the same and having a plurality of second openings communicating with the first openings, and
fastener means attached to the strainer member for fixing the strainer member to the strainer supporting member.

2. A papermaking strainer according to claim 1, wherein said strainer member includes divided members having portions facing the inflow side of the papermaking raw material.

3. A papermaking strainer according to claim 1, wherein said first openings have an opening size same as that of the second openings, and are aligned with the second openings, said strainer member except for the first openings abutting against the strainer supporting member and being supported by the strainer supporting member.

4. A papermaking strainer according to claim 1, wherein said second openings have a size larger than that of the first openings and are wider as outlets of the papermaking raw material through the first openings.

5. A papermaking strainer according to claim 1, wherein said strainer supporting member includes a protrusion at a center side thereof, said fastener means is a ring member attached to an outer side of the strainer supporting member so that the strainer member is held between the protrusion and the ring member.

6. A papermaking strainer according to claim 5, wherein said protrusion and ring member have tapered portions at sides contacting the strainer member to hold the same.
